(19) United States
(12) Patent Application Publication
(10) Pub. No.: US 2012/0185164 A1
(43) Pub. Date: Jul. 19, 2012

(54) CELLULAR AND GPS TRAINING TARGET ZONE DYNAMIC PLANNING AND ROUTING

(75) Inventors: Justin A. McCoy, Poughkeepsie, NY (US); Thomas E. Murphy, JR., Hopewell Junction, NY (US)

(73) Assignee: INTERNATIONAL BUSINESS MACHINES CORPORATION, Armonk, NY (US)

(21) Appl. No.: 13/007,289

(22) Filed: Jan. 14, 2011

(51) Int. Cl. G01C 21/00

(52) U.S. Cl. 701/423

(57) ABSTRACT

Exemplary embodiments include a method for target zone dynamic planning, the method including receiving metric data, collecting location data, determining a targeted energy expenditure zone for a time period, calculating potential plans based on location and the metric data and calculating an energy cost for different paths based on variables associated with the metric data.

### BACKGROUND

The present invention relates to dynamic planning, and more specifically, to systems and methods that determine targeted energy expenditure zones.

Many activities include prior planning to determine a route. For example, when driving, a user may consult paper or electronic mapping systems to determine a route, which may include a shortest route of shortest or a route that avoids certain impediments such as mountains or tolls. When training/working out outdoors a runner may plan a route before running or change pace and direction based on knowledge of an area and the runner's own abilities in order to continue training in a predefined zone, such as a targeted heart rate based on age. Zones are typically defined by the user, such as setting an 80% threshold for a heart rate in which the route includes hills. Such a predefined zone is improved with a heart rate monitor where one the runner can view if they are training in a particular zone but will fluctuate in and out of the target based on location. While training one can wear a Global Positioning System (GPS) device to show their route and heart rate at points along the route post activity. Having dynamic routing based on location, goal, and heart rate or other indicator ensures that the user stays within a defined zone and doesn't need to know the complete route ahead of time.

Currently there are GPS/Heart rate devices trainers use to record path and heart rate along a course making the data available post activity or by snapshots (every time you look at the heart rate monitor). However, such a solution does not allow for the route to be dynamically routed. A user in training might feel “good” during a session but does not maximize their workout because it was planned out ahead of time. The user also might have chosen a target heart rate and course only to find they exceed their target heart rate half the way up a hill or during the first hill of a series of hills in the route planned before starting the activity.

### SUMMARY

Exemplary embodiments include a method for target zone dynamic planning, the method including receiving metric data, collecting location data, determining a targeted energy expenditure zone for a time period, calculating potential plans based on location and the metric data and calculating an energy cost for different paths based on variables associated with the metric data.

Additional exemplary embodiments include a computer program product for providing a targeted energy expenditure zone, the computer program product including a non-transitory computer readable medium having instructions for causing a computer to implement a method, the method including receiving metric data, collecting location data, determining a targeted energy expenditure zone for a time period, calculating potential plans based on location and the metric data and calculating an energy cost for different paths based on variables associated with the metric data.

Further exemplary embodiments include a system for target zone dynamic planning, the system including a processor configured to receive metric data, collect location data, determine a targeted energy expenditure zone for a time period, calculate potential plans based on location and the metric data and calculate an energy cost for different paths based on variables associated with the metric data.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates an exemplary embodiment of a system for indentifying and maintaining targeted energy expenditure zones; and

FIG. 2 illustrates a flow chart for a method for training target zone dynamic routing in accordance with exemplary embodiments.

### DETAILED DESCRIPTION

Exemplary embodiments include systems and methods for determining targeted energy expenditure zones. For illustrative purposes exemplary systems and methods for training (e.g., running) target zone dynamic routing are discussed. However, it is appreciated that the systems and methods described herein can also be implemented with any activity that includes a targeted energy expenditure zone. For example, the systems and methods described herein can be implemented to determine targeted energy expenditure zones (e.g., fuel consumption) for vehicle trips.

In exemplary embodiments, the exemplary systems and methods described herein enable dynamic planning of a training course based on a user's target zone, current sensory conditions and current body conditions. In exemplary embodiments, the system can include sensory cues such as kinesthetic (e.g., vibration), visual and audio cues, giving directions to the user. In exemplary embodiments, the system can further include a GPS to determine position, a cellular network to interface with electronic maps gathering elevation, road and park information, a heart rate monitor or other indicator to monitor current physical condition during the workout.

Before beginning a workout, a user sets a target zone for heart rate and activity such as hills flat or mixed during the training activity. Activities such as running, skiing, biking and the type of path are selected (e.g. paved or mountain trail etc.). Thus as the user's heart rate or other health indicator changes a route that is less hilly or more hilly can be selected to maximize the workout efficiency. Route changes can be relayed to the user via cues as described herein.

In exemplary embodiments, a desirable form factor for the targeted energy expenditure zone system is a portable device encompassing a GPS, clock, sensory readers for both environmental conditions (e.g., barometric pressure, ambient temperature and any other metric used to calculate oxygen density in real time) and user-specific conditions (e.g., heart rate and respiration), network interface, and devices for providing cues such as an audio player (e.g., MP3 player) and a visual display. An exemplary targeted energy expenditure zone system is now described. It is appreciated that the exemplary system can be modified in accordance with any desired targeted energy expenditure zone goals.

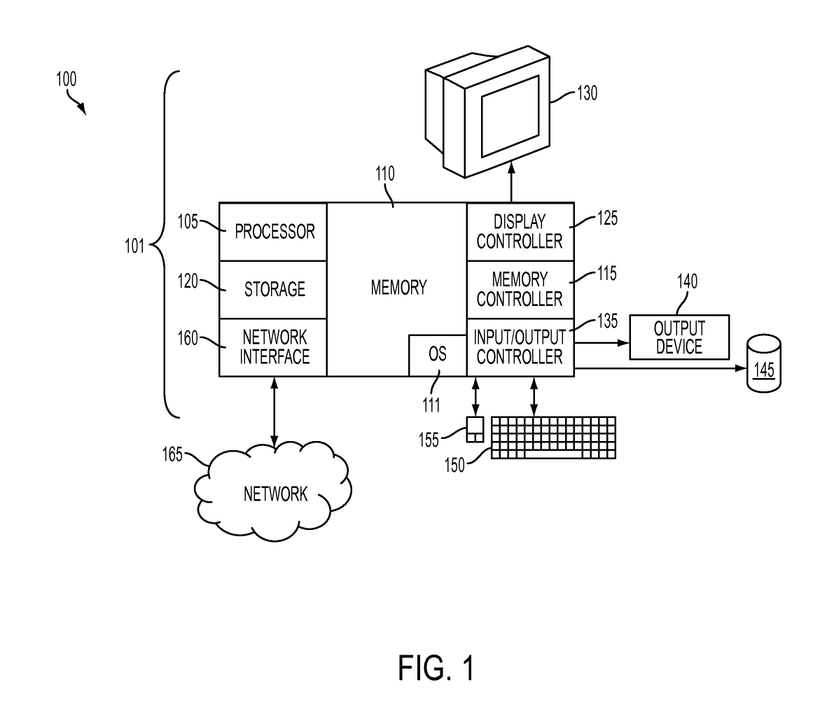

FIG. 1 illustrates an exemplary embodiment of a system 100 for indentifying and maintaining targeted energy expenditure zones. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101. It is appreciated that the general purpose computer is embodied in a desirable portable device.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, but is not limited to, one or more buses or other wired or wireless connections, as is known in the art. The input/output controller 135 may have additional elements, which are omitted for simplicity, such as controllers, buffers (caches), drivers, repeaters, and receivers, to enable communications with a network as described herein. Further, the local interface may include address, control, and/or data connections to enable appropriate communications among the aforementioned components. For example, the system 100 may include a cellular network to interface with electronic maps to gather elevation, road and park information.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as a dynamic RAM (DRAM), static RAM (SRAM), synchronous DRAM (SDRAM), etc.)) and nonvolatile memory elements (e.g., read only memory (ROM), erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the targeted energy expenditure zone methods described herein in accordance with exemplary embodiments and a suitable operating system (OS) 111. The operating system 111 essentially controls the execution of other computer programs, such the targeted energy expenditure zone systems and methods as described herein, and provides scheduling, input-output control, file and data management, memory management, and communication control and related services.

The targeted energy expenditure zone methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the targeted energy expenditure zone methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. It is appreciated that the keyboard 150 and mouse 155 are suitably sized for a portable device and may include other form factors such as a touch screen for input and output in lieu of the keyboard 150 and mouse 155. Other output devices such as the I/O devices 140, 145 may include input devices, for example but not limited to a printer, a scanner, microphone, and the like. As described herein, the I/O devices 140, 145 may include a GPS to determine position, a cellular network to interface with electronic maps gathering elevation, road and park information, an environmental conditions monitor and a heart rate or respiration monitor or other indicator to monitor current physical state during workout. The I/O devices can further include any audio or video device that can provide both entertainment for the user such as an MP3 player, as well as sensory cues to alert the user of route changes. For example, route changes can be relayed via headphones either interrupting music or over music being played. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The targeted energy expenditure zone methods described herein and the OS 111, in whole or in part, but typically the latter, are read by the processor 105, perhaps buffered within the processor 105, and then executed.

When the systems and methods described herein are implemented in software, as is shown in FIG. 1, the methods can be stored on any computer readable medium, such as storage 120, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the targeted energy expenditure zone methods are implemented in hardware, the targeted energy expenditure zone methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In exemplary embodiments, inputs for the system 100 can include several metric data, but are not limited to: GPS location; heart rate; respiration; body temperature; location based on topographic information; GPS destination; type of activity (e.g., running, biking and skiing); type of training (e.g., interval, weight loss, speed and distance); target zones over course of session, (e.g., start zone 0 from 0-5 min period, zone 2 5-30 min period with 5 30 second intervals of zone 4, zone 1 30-45 min period); activity duration; age; height; barometric pressure; oxygen density; ambient temperature; elevation and weight. It is understood that various other inputs are possible in other exemplary embodiments.

In exemplary embodiments, outputs (including kinesthetic/audio/visual cues) for the system 100 can include, but are not limited to: direction; current zone; total distance; pace; all of the above for a time slice (e.g., current pace 8 mph, heading NW, 5.3/10 miles completed, within goal of zone 3).

In exemplary embodiments, known data for the system 100 can include, but are not limited to: behaviors of a runner (e.g., going up hills raise the heart rate, such as a percent gradient change/distance equals a percentage rise in heart rate; and training zone charts for algorithm lookup and modification describing heart rate or other signs of energy expenditure for expected age/weight/height. Such examples include methods by Karvonen, Conconi and Dijkstra as known in the art.

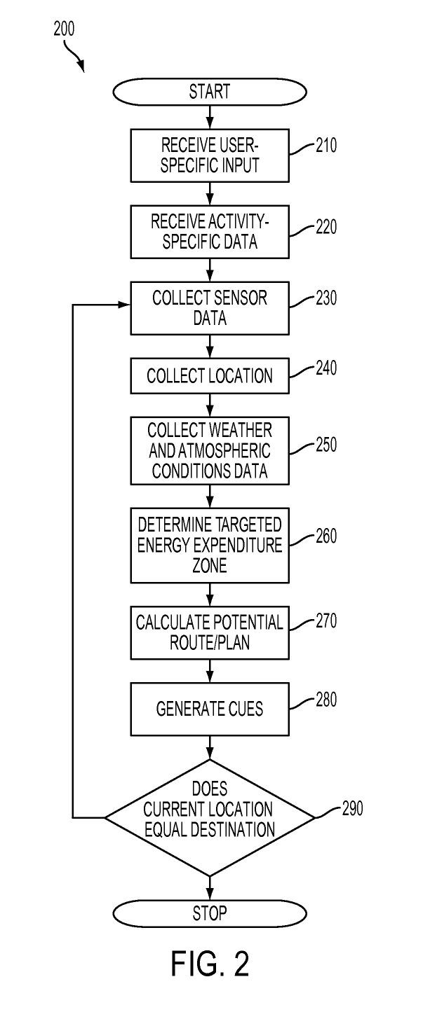

FIG. 2 illustrates a flow chart for a method 200 for training target zone dynamic routing/planning in accordance with exemplary embodiments. At block 210, the system 100 receives user-specific inputs (e.g., age, weight, height). In exemplary embodiments, the user can enter these inputs via one of the I/O devices 140, 145. At block 220, the system 100 receives activity-specific data (e.g., activity type, duration, and zone). In exemplary embodiments, the user can enter these inputs via one of the I/O devices 140, 145. At block 230, the system 100 receives sensor data (e.g., hour temperature). In exemplary embodiments, the system 100 automatically receives this data via one of the I/O devices 140, 145, such as an internal clock and temperature monitor. At block 240, the system 100 can collect current location data. In exemplary embodiments, the system 100 automatically receives this data via one of the I/O devices 140, 145, such as a GPS. At block 250, the system 100 can collect current weather and atmospheric conditions for the current location or target location being simulated. In exemplary embodiments, the system 100 automatically receives this data via the network 165 for example. At block 260, the system 100, based off of the users input can determine the targeted energy expenditure zone for a time period. At block 270, the system 100 can calculate potential routes (plans) based off current location using mapping data, weather reports, topographic data, heart rate, destination, activity duration target, distance target, zone target (for a time period). In exemplary embodiments, the system 100 can implement graph algorithms stored in the memory 100 to calculate the energy cost for different paths based on variables including, but not limited to: distance; gradient change; and weather (wind speed, direction and the like). This information gives each potential direction a weight, higher weights use more energy then lower weights. The system 100 can further implement algorithms to associate weights with zones. In addition, the system 100 can select a path that has weights closely related to the target zone for the upcoming time period. At block 280, during actual training, the system 100 can dynamically provide sensory cues to user describing direction and speed. In exemplary embodiments, the system 100 automatically receives this data via one of the I/O devices 140, 145, such as headphones and the display 130. At block 290, the system 100 determines if the user's current location is equal to the destination. If the current location is not equal to the destination, then the dynamic method 200 continues at block 230. If the current location does match the destination, then the user has attained the goal and the method 200 terminates.

The exemplary embodiments described herein have described systems and methods for training (e.g., running) target zone dynamic routing largely with respect to outdoor training. In other exemplary embodiments, the systems and methods described herein could be implemented for indoor training as well. As such, the systems and methods described herein can be implemented to training indoors to factor in conditions that may exist. For example, a person may be traveling to mountainous region (e.g., Denver) on business to a location at sea level (e.g., New York City). The systems and methods described herein can therefore factor in elevation and not merely topography in to a routine that simulates the mountainous locale. In this way, a person can train locally at a different elevation, temperature, air density (e.g., barometric pressure and the like) with the objective being that the exercise equipment takes input for Denver's various metrics and calculates and adapts a special regimen considerate of both the local and target geographies (or conversely).

In this way, target heart rate zones and the like can be attenuated accordingly based on the amount of time the person may have been acclimated to the different elevation. Associating target heart rates with elevation allows for setting a reasonably achievable heart rate once the elevation is factored in. The data could also be manually input during equipment setup and installation. In exemplary embodiments, other non-GPS related inputs including manual input when stationary exercise equipment is used. In can be implemented for altitude (e.g., simple coordinates obtained from GPS), including manual input when a stationary exercise equipment is used. In this way, in the example above, someone training on stationary equipment situated in New York City could input a desired latitude/longitudinal coordinates for an upcoming race for an upcoming race in Denver, where the elevation is over 5000 feet. Hence said stationary equipment could factor the input and set target heart rates accordingly. In general, including altitude as an input variable is valuable for training routines that produce different distances and routes. These changes for energy use are shown in studies where runners not acclimated to higher altitudes lose 10-12% of their maximal oxygen uptake (VO2Max) at 6500 feet. This feature has a similar but reversed effect on auto engines in which the compression is reduced at higher elevations producing greater fuel efficiency.

Technical effects of the dynamic routing allows users the benefit of time spent training while minimizing the time required for detailed course planning based on targeted zones.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for target zone dynamic planning, the method comprising:
receiving metric data;
collecting location data;
determining a targeted energy expenditure zone for a time period;
calculating potential plans based on location and the metric data; and
calculating an energy cost for different paths based on variables associated with the metric data.

2. The method as claimed in claim 1 wherein the metric data is user-specific data.

3. The method as claimed in claim 1 wherein the metric data is activity-specific data.

4. The method as claimed in claim 1 wherein the metric data is sensor data.

5. The method as claimed in claim 1 wherein the metric data is at least one of weather and atmospheric data.

6. The method as claimed in claim 1 further comprising associating the targeted energy expenditure zone with the metric data.

7. The method as claimed in claim 6 wherein a path is selected based on the metric data that is related to the targeted energy expenditure zone for an upcoming time period.

8. The method as claimed in claim 1 further comprising generating sensory cues based on changing metric data.

9. A computer program product for providing a targeted energy expenditure zone, the computer program product including a non-transitory computer readable medium having instructions for causing a computer to implement a method, the method comprising:
receiving metric data;
collecting location data;
determining a targeted energy expenditure zone for a time period;
calculating potential plans based on location and the metric data; and
calculating an energy cost for different paths based on variables associated with the metric data.

10. The computer program product as claimed in claim 9 wherein the metric data is user-specific data.

11. The computer program product as claimed in claim 9 wherein the metric data is activity-specific data.

12. The computer program product as claimed in claim 9 wherein the metric data is sensor data.

13. The computer program product as claimed in claim 9 wherein the metric data is at least one of weather and atmospheric data.

14. The computer program product as claimed in claim 9 wherein the method further comprises associating the targeted energy expenditure zone with the metric data.

15. The computer program product as claimed in claim 14 wherein a path is selected based on the metric data that is related to the targeted energy expenditure zone for an upcoming time period.

16. The computer program product as claimed in claim 1 wherein the method further comprises generating sensory cues based on changing metric data.

17. A system for target zone dynamic planning, the system comprising:
a processor configured to:
receive metric data;
collect location data;
determine a targeted energy expenditure zone for a time period;
calculate potential plans based on location and the metric data; and
calculate an energy cost for different paths based on variables associated with the metric data.

18. The system as claimed in claim 17 further comprising a global positioning system operatively coupled to the processor and configured to receive the location data and generate a destination.

19. The system as claimed in claim 17 further comprising a network interface operatively coupled to the processor and configured to receive the metric data.

20. The system as claimed in claim 17 further comprising input/output devices operatively coupled to the processor configured to provide sensory cues based on the metric data and the targeted energy expenditure zone.
